(19) United States
(12) Patent Application Publication
(10) Pub. No.: US 2005/0186036 A1
(43) Pub. Date: Aug. 25, 2005

(54) Method and tool for production of an inner part of a constant-velocity joint

(76) Inventors: Oliver Doerfel, Koengen (DE); Andreas Franke, Lorch (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/499,008

(22) PCT Filed: Nov. 14, 2002
(86) PCT No.: PCT/EP02/12745

(30) Foreign Application Priority Data
Dec. 21, 2001 (DE) 101 63 040.9

(51) Int. Cl. B26D 1/12

(52) U.S. Cl. 407/31

(57) ABSTRACT

Cylindrical milling is used to produce ball raceways on an outer circumferential surface of a joint inner part for a constant-velocity rotary joint. To do this, a cylindrical milling tool with a large number of milling teeth based on the diameter of the tool is used in order to achieve a high advance rate.

### BACKGROUND AND SUMMARY OF THE INVENTION

The present invention relates to a process for producing a joint inner part for a constant-velocity rotary joint with a plurality of circumferentially distributed ball raceways for accommodating torque-transmitting balls, and to a suitable tool for carrying out this process.

German document DE 35 08 487 C2 has disclosed discloses various processes for producing joint inner parts for constant-velocity rotary joints: it joints. It is known in particular to produce a joint inner part blank by casting or forging and then to introduce the ball raceways into the joint inner part blank in the cold, semi-hot or hot state by grinding, chip-forming machining or deformation. If an accurately specified form of the ball raceway is to be achieved, it is customary for the approximate contours of the ball raceways to be formed into the joint inner part blank by cold-working or forging and then for the desired highly accurate shape of the ball raceways to be produced by chip-forming machining, in particular grinding. Grinding entails high levels of tool wear, and consequently grinding-relief sections which are intended to relieve the grinding forces are provided in the raceways. The introduction of these grinding-relief sections entails increased machining outlay; furthermore, grinding is a relatively time-consuming process.

The One object of the invention is based on the object of providing a process which allows the ball raceways to be introduced into joint inner parts with a high level of accuracy and within a significantly shorter time than has been the case with conventional processes. Furthermore, Another object of the invention is based on the object of providing a tool for carrying out this process.

According to the invention, the object is achieved by the features of claims 1 and 2.

Accordingly, the ball raceways are introduced into the joint inner part by means of cylindrical milling. Cylindrical milling per se is a known process, which has hitherto been used in particular to produce grooves (as described for example in German document DE 295 11 482 U1) or to machine crankshaft bearings (as described for example in German document DE 198 01 862).

The main cylindrical milling variable which determines time and therefore productivity is the advance rate v_{f}. It is dependent, in accordance with the formula

$${v}_{f} = \frac{{f}_{z} \times z \times {v}_{c}}{π \times {d}_{Wz}} \qquad ( I )$$

(source: Degner, Lutze, Smejkal: “Spanende Formung” [Chip-forming shaping], Carl Hanser Verlag Munich 1993), on the tooth advance f_{z}, the number of teeth z, the cutting velocity v_{c} and the tool diameter d_{Wz}. To achieve maximum productivity, the smallest possible tool diameter d_{Wz} should be the objective for a given tooth advance f_{z} and a given number of teeth z. In the past, it has only been possible to achieve low advance rates v_{f} and low levels of accuracy, and consequently cylindrical milling has never hitherto been considered a suitable process for the production of raceways in constant-velocity rotary joints.

According to the invention, it is proposed that cylindrical milling be used to produce raceways in constant-velocity rotary joints. The invention is based on the consideration that in the meantime new cutting materials (in particular hard metals) have become available at economically acceptable prices. Using milling cutters made from cutting materials of this type, it is possible, in accordance with formula (I), to achieve high advance rates v_{f} even with small milling cutter diameters d_{Wz}, in particular if a large number z of milling teeth are provided on the circumference of the milling cutter. The advantages of the small tool diameter d_{Wz} reside in the high tool stability (low axial deformation and susceptibility to vibration), the low torque loading on the main spindle and, finally, a significantly lower price. Furthermore, in recent years high-performance CNC machine tools have been developed, which are suitable for the production of complex geometries.

Therefore, if a tool made from a high-performance material (preferably a hard metal with a hard material coating, cf. claim 7)coating) and a large number z of milling teeth along the circumference of the cylindrical milling cutter is used, it is possible to achieve the object of forming ball raceways quickly, highly accurately and at low cost into a joint inner part of a constant-velocity rotary joint in a surprisingly simple way by using cylindrical milling. The support reaction forces can be determined and compensated for by measuring the cutting forces during the cylindrical milling, so that it is possible to satisfy the high demands on accuracy imposed on ball raceways on joint parts. Furthermore, the high material-removal rate makes it possible to achieve a short machining time and therefore a high productivity.

A tool which comprises a milling body in disk form with milling teeth arranged on the circumferential surface, with the quotient formed from the number of milling teeth and the diameter of the milling body being greater than 0.25 tooth/mm cf. claim 2) , tooth/mm, is used to carry out the process according to the invention. As described above, this makes it possible to achieve high advance rates v_{f} for the tool with respect to the joint inner part and therefore very short machining times.

The cylindrical form milling of the ball raceways of the constant-velocity rotary joint may be a two-stage process comprising a roughing step and a finishing step. These two process steps can be combined in a particularly advantageous, time-saving way if the roughing milling tool is mounted together with the finishing milling tool on the same tool spindle (cf. claim 3). spindle. In this case, the process kinematics can be selected in such a way that the machine non-productive time required for the return movement of the roughing tool is used for the finishing process. This allows the cycle time to be considerably shortened. It is preferable for the number of teeth on the roughing tool and finishing tool to be equal (cf. claim 4). equal. Alternatively, it is possible to use a single milling tool which carries out a roughing action in the advancing movement and a finishing action in the return movement.

Using the process according to the invention, it is possible to introduce the ball raceways into a previously unmachined blank. To ensure that the wide chips which are produced during the roughing operation are transported out of the relatively small chip space of the roughing tool, the roughing tool is expediently provided with chip-divider grooves (cf. claim 5). grooves. The chip-divider grooves break the wide chips into short chip segments, preventing the chips from becoming jammed in the chip space of the tool.

On account of the large number of milling teeth based on the milling body diameter, the chip space available on the milling tool for removal of the milling chips is very small. Experience has shown that the chips produced can nevertheless be removed reliably from the process if the milling teeth are arranged at a rake angle of preferably between 5 and 12 degrees (cf. claim 6) degrees.

The text which follows provides a more detailed explanation of the invention on the basis of an exemplary embodiment illustrated in the drawings, in which: drawings.

### BRIEF DESCRIPTION OF THE DRAWINGS

FIG. 1a shows a joint inner part of a rotary joint;

FIG. 1b shows a blank used to produce the joint inner part shown in FIG. 1a;

FIG. 2a illustrates the roughing of the joint inner part blank;

FIG. 2b illustrates the finishing of the joint inner part blank; and

FIG. 3 shows a side view of the tool illustrated in FIG. 2a.

### DETAILED DESCRIPTION OF THE INVENTION

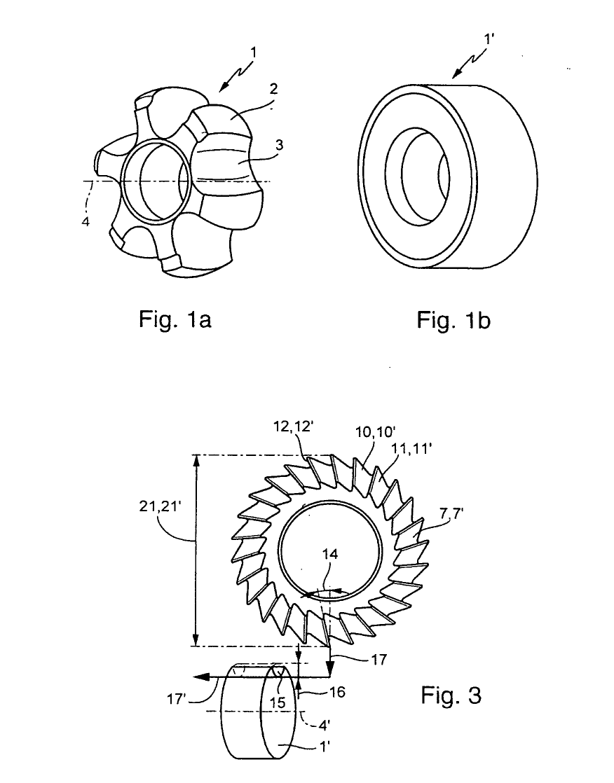

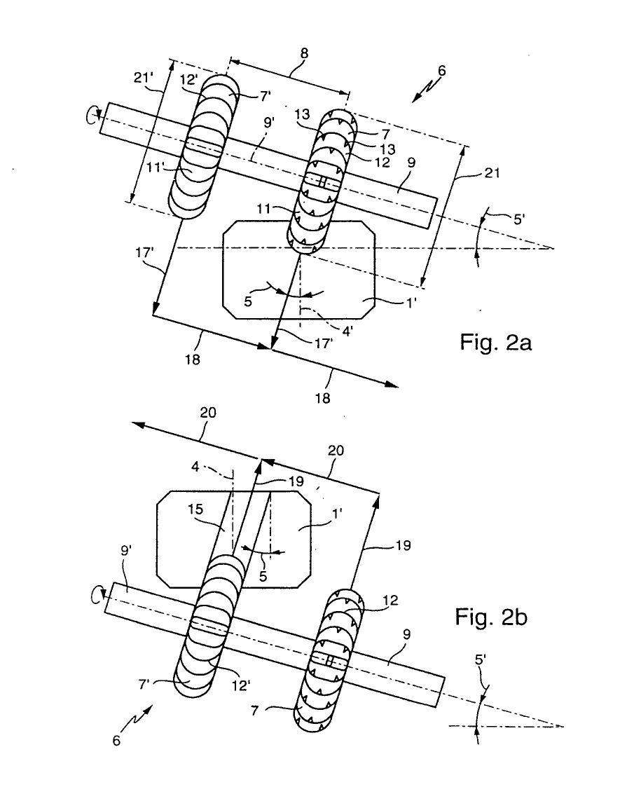

FIG. 1a shows a joint inner part 1 of a constant-velocity rotary joint which has been produced from a joint inner part blank 1′ (FIG. 1b). The joint inner part 1 has, on its outer circumferential surface 2, a plurality of ball raceways 3, in which, in the assembled state of the joint inner part 1 with a joint outer part (not shown in FIG. 1a), torque-transmitting balls are accommodated. The ball raceways 3 extend substantially in the longitudinal direction of the joint inner part 1; in the example shown in FIG. 1a, the ball raceways 3 are arranged parallel to the axis of symmetry 4 of the joint inner part 1; with these geometries, the raceway shape is curved. In other forms of rotary joints, the ball raceway 3 is tilted through an angle of inclination 5 with respect to the axis of symmetry 4 of the joint inner part 1 (cf. FIGS. 2a and 2b).

FIG. 2a shows a milling tool 6 for producing the ball raceways 3 on the joint inner part blank 1′ shown in FIG. 1b. The milling tool 6 comprises two cylindrical milling cutters 7, 7′, a roughing cutter 7 and a finishing cutter 7′, which are jointly arranged on a rotary spindle 9, axially offset from one another by a distance 8. The two milling cutters 7, 7′ have a diameter 21, 21′. As can be seen from the side view presented in FIG. 3, each milling cutter 7, 7′ has a multiplicity of milling teeth 11, 11′ on its circumferential surface 10, 10′; the cutting contour 12, 12′ is calculated from the shape of the ball raceway 3 to be produced. In addition to the straight-toothed milling cutters 7, 7′ shown in FIGS. 2a and 2b, it is also possible to use obliquely toothed milling cutters.

The milling teeth 11 of the roughing cutter 7 are provided with chip-divider grooves 13 in order to ensure that the chips are transported out of the chip space of the roughing cutter 7 during the roughing process. Since the chips produced during the finishing operation are much smaller, there is no need for chip dividers to be present at the milling teeth 11′ of the finishing cutter 7′.

In the present exemplary embodiment, the roughing cutter 7 and finishing cutter 7′ are each of single-part design. Both milling cutters 7, 7′ are solid hard-metal tools provided with a hard material coating (e.g. with a TiAlN multilayer coating). The joint inner part blank 1′ consists of a steel material, e.g. Cf53. The cutting speeds v_{c} for these combinations of materials are within the standard range for such tools, namely from 300 m/min to 400 m/min.

In the present exemplary embodiment, both the roughing cutter 7 and the finishing cutter 7′ have 26 milling teeth 11, 11′, and both cutters have a diameter d_{Wz} of 80 mm. At cutting speeds v_{c} of 300 m/min to 400 m/min and a tooth advance f_{z}=0.12, it is possible with milling cutters 11, 11′ of this type—in accordance with formula (I)—to reach advance rates v_{f} of from 3000 mm/min to 6000 mm/min. To ensure that the chips formed slide away in an appropriate way on the tool face, the rake angle 14 of the milling teeth 11, 11′ is in this case approximately 10°.

The following text will explain the kinematics involved in milling the ball raceways 3 into the joint inner part blank 1′, considering figures FIGS. 2a, 2b and 3 in combination with one another. During machining, the joint inner part blank 1′ is clamped into a chuck (not shown in figures FIGS. 2 and 3) with the aid of which the joint inner part blank 1′ can be rotated about its axis of symmetry.

To produce a ball raceway 3 which is tilted by an angle 5 with respect to the axis of symmetry 4′ of the joint inner part blank 1′, the rotary spindle 9 is tilted through the same angle 5′ with respect to a direction of rotation running perpendicular to the axis of symmetry 4′. Then, to carry out the roughing operation, the tool 6 is initially guided in such a way with respect to the joint inner part blank 1′ that the roughing cutter 7 introduces a flute-like groove 15 of depth 16 into the surface of the joint inner part blank 1′ (arrows 17 and 17′ in figures FIGS. 2a and 3). Then, the tool 6 is advanced along the spindle axis 9′ by an offset A (arrow 18 in FIG. 2a), where A corresponds to the distance 8 between roughing cutter 7 and finishing cutter 7′ on the tool spindle 9, so that the finishing cutter 7′ comes to lie opposite the flute-like groove 15 which has already been milled in. Then, the tool 6 is initially guided in such a way with respect to the joint inner part blank 1′ that the finishing cutter 7′ finely machines the region of the flute-like groove 15 which has been introduced in the first process step, so as to produce the final shape of the ball raceway 3 (arrow 19 in FIG. 2b). Finally, the tool 6 is moved back into the starting position by being displaced back by the offset Δ in the direction of the spindle axis 9′ (arrow 20 in FIG. 2b). In this way, the first ball raceway 3 is completed and the joint inner part blank 1′ can be rotated by means of the chuck in order for a further ball raceway 3 to be introduced into the outer circumferential surface of the joint inner part blank 1′.

In addition to this preferred embodiment of the invention illustrated in figures FIGS. 2a and 2b, in which two separate milling cutters 7, 7′ are used for the roughing operation and the finishing operation, it is also possible for the two machining steps to be carried out using a single milling cutter, which carries out the roughing operation in its advancing movement and the finishing operation in its return movement. In addition to the kinematics illustrated in figures FIGS. 2a and 2b, in which a ball raceway is firstly roughed and finished before machining of the next ball raceway commences, it is also possible for a plurality of ball raceways to be roughed in succession first of all, followed by finishing of these ball raceways in succession. Furthermore, depending, for example, on the combination of materials and/or the desired quality of the ball raceway to be produced, it may be sufficient to carry out just one roughing operation, without subsequent finishing.

In the process kinematics illustrated in figures FIGS. 2a and 2b, the tool 6 is displaced with respect to the workpiece 1′ clamped in the chuck during the machining operation. In principle, it is also possible for the advancing movements to be carried out by the workpiece 1′. Which of the relative movements are carried out by the workpiece 1′ and which are carried out by the tool 6 depend on the particular machine.

During the hardening process which follows the chip-forming machining, the joint inner part is deformed so that the ball raceways are curved. To avoid expensive rework, this curvature must be taken into account in the milling process.

The process and tool according to the invention can be used to mill both straight and curved ball raceways 3 into joint inner part blanks 1′. In addition to the elliptical cutting contour 12, 12′ of the cutting teeth 11, 11′ shown in figures FIGS. 2 and 3, the milling teeth 11, 11′ may also have other cutting contours (e.g. trapezoidal cutting contours), in order to produce ball raceways with a rectangular or trapezoidal cross section instead of the ball raceways 3 with an elliptical cross section shown in FIG. 1a.

In addition to the milling cutters 7, 7′ of single-part configuration shown in figures FIGS. 2a, 2b and 3, it is also possible to use milling cutters with cutting tips which can be inserted individually. This has the advantage that in the event of wear to individual milling teeth 11, 11′, it is not necessary to replace the entire milling cutter 7, 7′, but rather only the defective cutting tip has to be replaced. In this case, the cutting tips which form the milling teeth 11, 11′ are preferably attached to the milling cutter by brazing or clamping.

1-6. (canceled)

7. A tool for producing ball raceways on a joint inner part for a constant-velocity rotary joint with aid of cylindrical form milling, comprising a disk-like milling body with milling teeth arranged on the circumferential surface, wherein a quotient formed from a number of milling teeth and a diameter of the milling body is greater than 0.25 tooth/mm, and wherein a cutting contour of the milling teeth corresponds to a shape of the ball raceway to be produced:

8. The tool as claimed in claim 7, wherein the disk-like milling body is a first milling body, and further comprising a further milling body in disk form which is axially offset with respect to the first milling body, and wherein one of the first and second milling bodies is configured as a roughing tool and the other of the first and second milling bodies is configured as a finishing tool.

9. The tool as claimed in claim 8, wherein the quotient formed from the number of milling teeth and the diameter of the milling body is equal on the roughing tool and the finishing tool.

10. The tool as claimed in claim 8, wherein the roughing tool has chip divider grooves.

11. The tool as claimed in claim 7, wherein the milling teeth are arranged at a rake angle of between 5° and 12° on the milling body.

12. The tool as claimed in claim 7, wherein the milling body consists of a hard metal coated with hard material.

13. The tool as claimed in claim 9, wherein the roughing tool has chip divider grooves.

14. The tool as claimed in claim 8, wherein the milling teeth are arranged at a rake angle of between 5° and 12° on at least one of the first and second milling bodies.

15. The tool as claimed in claim 9, wherein the milling teeth are arranged at a rake angle of between 5° and 12° on at least one of the first and second milling bodies.

16. The tool as claimed in claim 10, wherein the milling teeth are arranged at a rake angle of between 5° and 12° on at least one of the first and second milling bodies.

17. The tool as claimed in claim 13, wherein the milling teeth are arranged at a rake angle of between 5° and 12° on at least one of the first and second milling bodies.

18. The tool as claimed in claim 8, wherein at least one of the first and second milling bodies consists of a hard metal coated with hard material.

19. The tool as claimed in claim 9, wherein at least one of the first and second milling bodies consists of a hard metal coated with hard material.

20. The tool as claimed in claim 10, wherein at least one of the first and second milling bodies consists of a hard metal coated with hard material.

21. The tool as claimed in claim 11, wherein the milling body consists of a hard metal coated with hard material.

22. The tool as claimed in claim 13, wherein at least one of the first and second milling bodies consists of a hard metal coated with hard material.

23. The tool as claimed in claim 14, wherein at least one of the first and second milling bodies consists of a hard metal coated with hard material.

24. The tool as claimed in claim 15, wherein at least one of the first and second milling bodies consists of a hard metal coated with hard material.

25. The tool as claimed in claim 16, wherein at least one of the first and second milling bodies consists of a hard metal coated with hard material.

26. The tool as claimed in claim 17, wherein at least one of the first and second milling bodies consists of a hard metal coated with hard material.
